(19) United States
(12) Patent Application Publication
(10) Pub. No.: US 2003/0068038 A1
(43) Pub. Date: Apr. 10, 2003

(54) Method and apparatus for encrypting data

(76) Inventor: Bedros Hanounik, San Jose, CA (US)

Correspondence Address: KENYON & KENYON, Suite 600, 333 W. San Carlos Street, San Jose, CA, 95110-2711, US

(21) Appl. No.: 09/968,262

(22) Filed: Sep. 28, 2001

(51) Int. Cl. H04K 1/04

(52) U.S. Cl. 380/37

(57) ABSTRACT

To improve data encryption and/or decryption, look-up tables in the field programmable gate array are used to store preselected values for the substitution box used in many encryption/decryption schemes. Utilizing look-up tables in such a manner reduces the overall gate count in the FPGA device resulting in quicker speeds, lower power consumption, and the ability to reconfigure the device for different encryption/decryption implementations.

### BACKGROUND OF THE INVENTION

The present invention pertains to the encryption of data. More particularly, the present invention pertains to using look-up tables in a programmable gate array to improve an encryption process.

There are a variety of encryption schemes known in the art. DES (Data Encryption Standard), is the name of the Federal Information Processing Standard (FIPS) 46-3, which describes the data encryption algorithm (DEA). The DEA is also defined in the ANSI (American National Standards Institute) standard X9.32. DES uses a 56-bit key to encrypt and decrypt 64-bit blocks of data. As known in the art, the DES algorithm is implemented with software and/or hardware components. In particular, the data to be encrypted is exclusive ORed (XOR) with the encryption key and forwarded to a substitution box (SBOX). In the SBOX, six bits of input data are replaced with a four-bit value depending on preset tables. Each of these tables is made up of sixteen columns and four rows of four-bit values (i.e., from 0 to 15 in decimal). To select the appropriate four-bit value, four of the bits of the input data are used to select one column and two of the bits are used to select a row. The corresponding four-bit value in the table is then output.

The output value of the SBOX is supplied to a permutation box (PBOX) component, which performs a permutation operation on the concatenation of the output values from the SBOX component. In a DES system, these steps are repeated sixteen times. In a Triple DES system, these steps are repeated 48 times with up to three key values.

In the art, there are generally two ways to create a hardware device to implement a DES encryption and/or decryption: application specific integrated circuits (ASIC) and field-programmable gate arrays (FPGA). Though an ASIC implementation is generally considered faster than an FPGA, it is very costly and time-consuming to create the desired ASIC. Also, to change the function of the ASIC requires a new design; the original integrated circuit cannot be modified to handle different functionality. The FPGA is made up of a number of configurable logic gates. One of the most common is a look-up table (LUT). A look-up table works like memory in that the input addresses a number of data locations in the LUT and the data found in the addressed data location is output from the device. Using software provided by the manufacturer of the FPGA device, the LUT is typically configured into a logic gate. For example, the LUT may implement any four-bit input logic gate that outputs a single bit. Thus, the LUT can store a value of 0 for addresses between 0000 and 1110 and can store a value of 1 for address 1111. The LUT then becomes an AND logic gate in that the output of the LUT will be 0 unless all input signal lines to the LUT have a value of 1 (then the output of the LUT will be 1.

Xilinx, Inc. of San Jose, Calif. manufactures the Vitrex® FPGA. Using software provided by Xilinx, the FPGA device can be configured to execute DES encryption and/or decryption. If the functionality of the device is to be changed, the same software may be used so as to change the functionality of the same integrated circuit. FPGAs tend to be slower and consume more power than ASICs. In implementing data encryption/decryption functionality into the FPGA, the software provided by the FPGA manufacturer would convert the abstract functionality into a set of interconnected logic gates so that the input values to the FPGA will achieve the desired output. Thus, each gate can be implemented using one of the LUTs provided on the FPGA device. Accordingly, though the functionality of the FPGA can be changed through a reconfiguration process, the FPGA device tends to be larger than the ASIC device performing the same function.

In view of the above, there is a need to implement DES in an integrated circuit device in an improved manner.

### BRIEF DESCRIPTION OF THE DRAWINGS

FIG. 1 is a block diagram of a circuit for implementation of a substitution box in a field programmable gate array (FPGA) according to an embodiment of the present invention.

FIG. 2 is a block diagram of a portion of a substitution box constructed according to an embodiment of the present invention.

FIG. 3 is a block diagram of a substitution box constructed according to an embodiment of the present invention.

### DETAILED DESCRIPTION

As discussed above, a substitution box (SBOX) is a component that is used in an encryption or decryption system. The SBOX receives m input bits and generates an n-bit output signal where the n-bit output value is selected from a number of preselected values based on the m-bit input value.

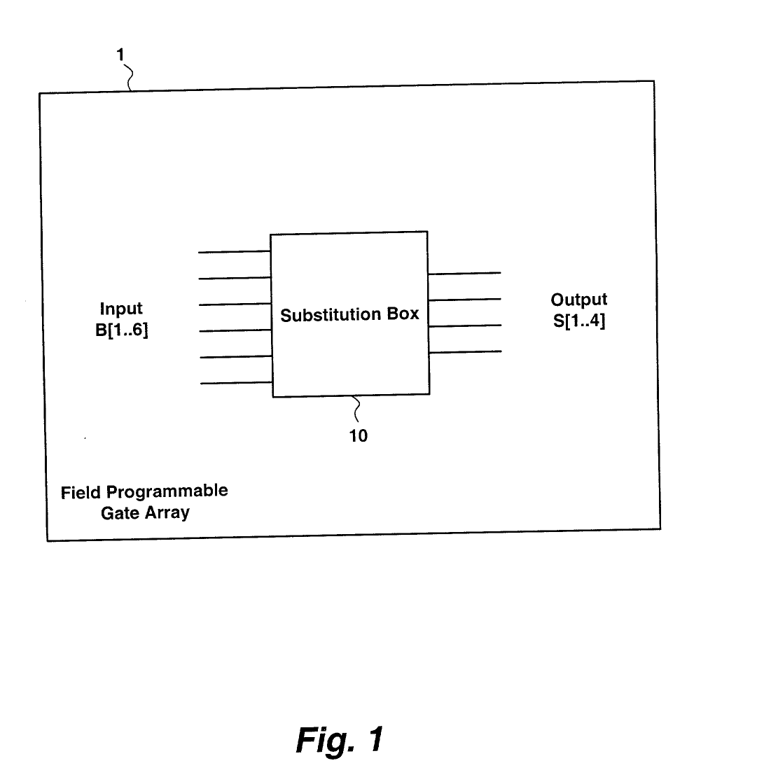

Referring to FIG. 1 a block diagram of an implementation for a substitution box in a field programmable gate array (FPGA) is shown. In this example, the FPGA 1 includes a number of SBOXs (one of which is shown as element 10). In this example, the SBOX includes an input of six bits (B[1 . . . 6]) that are used to select one of 64 preselected values to be output from the SBOX. In this example, the output signal is a 4-bit value.

An example of the preselected values is shown in Table 1. As shown in Table 1, each of the preselected values has four bits representing binary numbers 0000 to 1111 (0 to 15 in decimal). The preselected numbers can be arranged in four rows and sixteen columns. In the DES and TDES algorithms, two bits (B[1] and B[6]) of the six bit input value are used to select 15. the appropriate row and four bits (B[2 . . . 5]) of the input value are used to select the column in Table 1.

TABLE 1
Column

| Row | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| 0 | 14 | 4 | 13 | 1 | 2 | 15 | 11 | 8 | 3 | 10 | 6 | 12 | 5 | 9 | 0 | 7 |
| 1 | 0 | 15 | 7 | 4 | 14 | 2 | 13 | 1 | 10 | 6 | 12 | 11 | 9 | 5 | 3 | 8 |
| 2 | 4 | 1 | 14 | 8 | 13 | 6 | 2 | 11 | 15 | 12 | 9 | 7 | 3 | 10 | 5 | 0 |
| 3 | 15 | 12 | 8 | 2 | 4 | 9 | 1 | 7 | 5 | 11 | 3 | 14 | 10 | 0 | 6 | 13 |

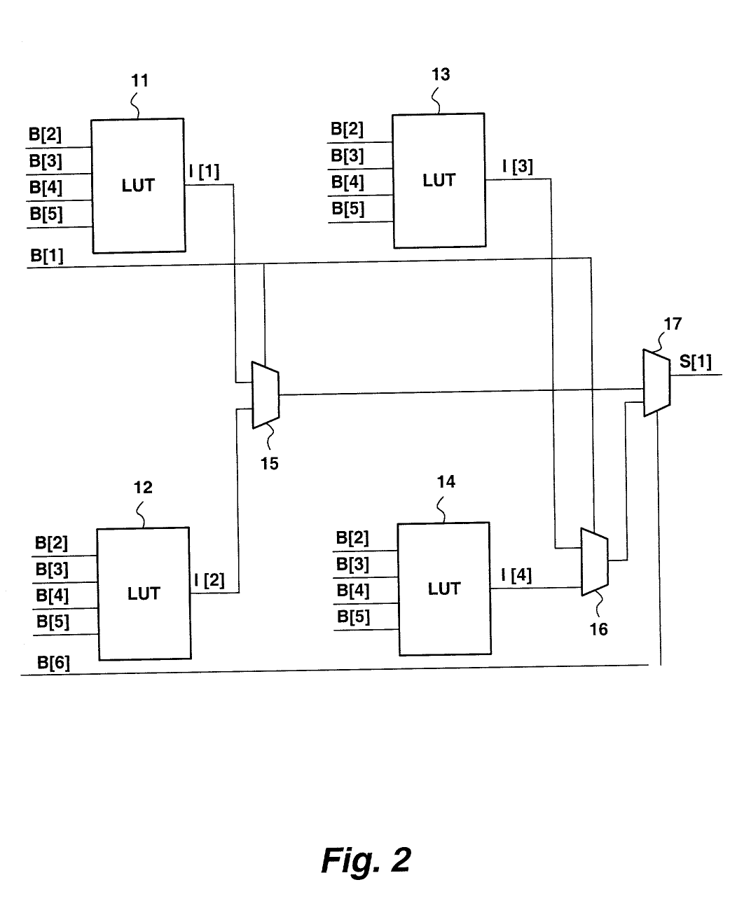

Referring to FIG. 2, a block diagram of a portion of the SBOX of FIG. 1 is shown constructed according to an embodiment of the present invention. Four bits B[2 . . . 5] are provided as inputs to each of four look-up tables 11, 12, 13, 14. In this embodiment, LUT 11 is used to generate an intermediate bit value I[1], which is input to a first multiplexer 15. A second LUT 12 is used to generate an intermediate value I[2] that is also input to the first multiplexer. Third and fourth intermediate values, I[3], I[4] are output by third and forth LUTs 13, 14, respectively. The outputs of the third and fourth LUTs are provided to a second multiplexer 16. Two bits B[1] and B[6] are provided as control inputs to multiplexers in the circuit of FIG. 2. For example, bit B[1] is used as the control input for multiplexers 15 and 16. Depending on the value of bit B[1], one of the inputs to each multiplexer is selected and output to a third multiplexer 17. Bit B[6] is used as the control input to the third multiplexer to select one of the outputs of multiplexers 15 and 16.

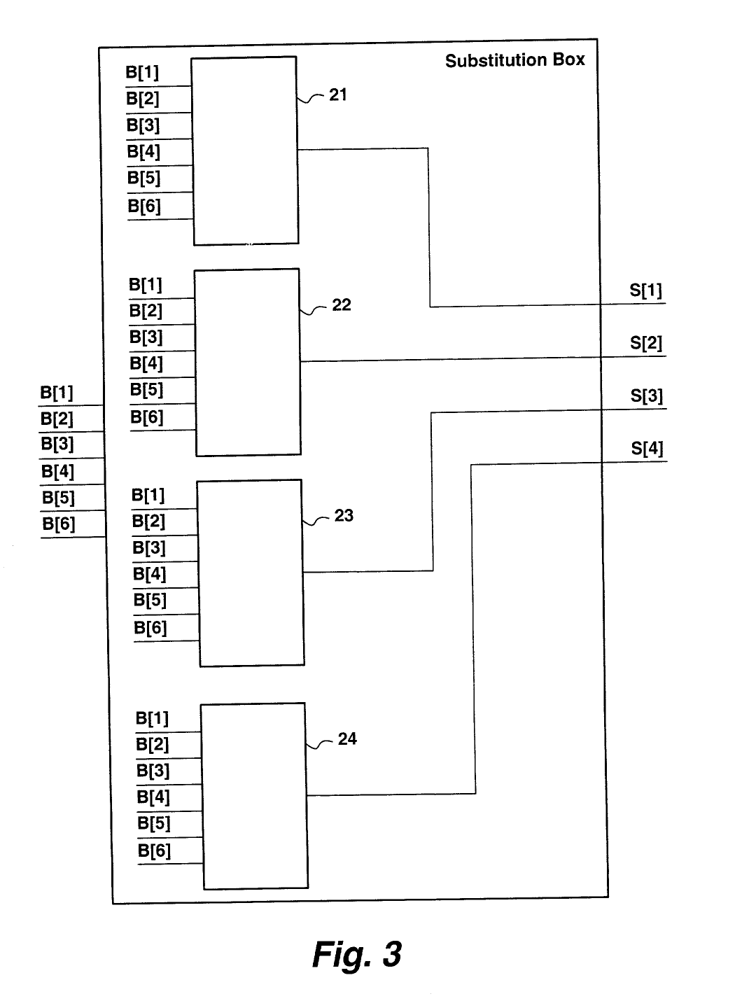

In this embodiment, the SBOX shown in FIG. 2 produces the first bit, S[1] of the four bit output S[1 . . . 4] shown in FIG. 1. As shown in FIG. 3, four of the circuits 21-24 shown in FIG. 2 are combined to generate the complete S[1 . . . 4] output. In a TDES and DES implementation, eight SBOXs are needed for each round of operation (one in DES and three in TDES). Each SBOX will have its own unique table (e.g., Table I) associated with it.

Referring back to FIG. 2, the portion of the SBOX is used to select the first bit, S[1] of the four-bit output signal of the SBOX shown in FIG. 3. Four of the input bits, B[2 . . . 5], are used to indicate a column in Table I. Thus, if these four input bits are set to 0000, they would point to the first bit in the four four-bit values in column 1 in Table 1 (in this example). The four bit values are 14, 0, 4, and 15. Thus, LUT 11 is configured to output a 1 bit in response to a four-bit input of 0000 (1 being the first bit of 1110-14 in decimal). Likewise, LUTs 12-14 are configured to output a 0 bit, a 0 bit, and a 1 bit, respectively, in response to a four-bit input of 0000. The four output bits, intermediate values I[1 . . . 4] are input to multiplexers 15 and 16. Two of the input bits, B[1] and B[6] are used to indicate the row in Table 1. Bit B[1] is used to select between I[1] and I[2] at multiplexer 15 and between bits I[3] and I[4] in multiplexer 16. Bit B[6] is used to select between the outputs of multiplexers 15 and 16 at multiplexer 17. If bits B[1] and B[6] point to row 0 in Table 1 (e.g., both bits are set to 0), then intermediate value I[1] should be output as bit S[1]. In multiplexers 15 and 16, with B[1] set to 0 selects intermediate values I[1] and I[3], respectively. In multiplexer 17, with B[6] set to 0, the output of multiplexer 15 (value I[1]) is selected and output as output bit S[1]. A similar operation would be performed in the other components of FIG. 3.

In one embodiment, the present invention may be used in the Vitrex® and Virtex®-E FPGA devices sold by Xilinx, Inc. (San Jose, Calif.). In this FPGA device there are a plurality of Configurable Logic Blocks or CLBs. Each CLB element includes two slices, and each slice includes two four-input function generators. Each function generator can be configured as a LUT. Accordingly, in this embodiment of the present invention, each function generator would be configured as a four-input LUT as indicated above to provide the appropriate output for the preselected substitution box values. Other components in these FPGA devices provide the multiplexers that achieve the functionality of the circuit of FIG. 2. To implement a substitution box using these FPGAs would require, four CLBs.

In another embodiment of the present invention, the Virtex®-II FPGA device is used. In this device, each CLB includes four slices and each slice includes two LUTs. The slices of the CLB include a number of multiplexers that can be connected with the LUTs as indicated above to provide the appropriate functionality of a substitution box. To implement a single substitution box, sixteen LUTs are needed. Thus, a substitution box of the present invention can be implemented using two CLBs in this particular FPGA device.

Using the present invention, the logic of the FPGA device can be efficiently used to create a substitution box resulting in shorter signal connections lengths (leading to faster operation) and reduced cost.

Although several embodiments are specifically illustrated and described herein, it will be appreciated that modifications and variations of the present invention are covered by the above teachings and within the purview of the appended claims without departing from the spirit and intended scope of the invention. For example, though the invention is described with respect to a DES and TDES encryption/decryption technologies, the present invention can be extended to other encryption technologies such as AES (Advanced Encryption Standard; National Institute of Standards and Technology—Draft of February, 2001 available at http://www.nist.gov/aes). Also, though the invention is described with respect to FPGA devices of Xilinx, Inc., it can be extended to FPGA devices of other companies as well.

What is claimed is:

1. A circuit to perform at least one of data encryption and data decryption, comprising:
a programmable gate array including at least one substitution box, said substitution box including at least one look-up table;
wherein said at least one look-up table is to receive m input bits and to generate an n-bit output signal where the n-bit output value is selected from a number of preselected values.

2. The circuit of claim 1 wherein m is 6 and n is 4

3. The circuit of claim 2 wherein said at least one look-up table is to store 16 preselected values.

4. The circuit of claim 1 wherein said substitution box includes first, second, third, and fourth look-up tables.

5. The circuit of claim 4 wherein m is 6 and n is 4.

6. The circuit of claim 5 wherein each of said look-up tables is to store 16 preselected values and said m inputs are to be used to select one preselected value from said look-up tables.

7. The circuit of claim 4 wherein a subset of said m input bits are used to select one preselected value from each of said first, second, third, and fourth look-up tables.

8. The circuit of claim 7 further comprising:
a first multiplexer coupled to outputs of said first and second look-up tables;
a second multiplexer coupled to outputs of said third and fourth look-up tables; and
a third multiplexer coupled to outputs of said first and second multiplexers, wherein one of said m input bits is to control said first and second multiplexers and a second of said m input bits is to control said third multiplexer.

9. A circuit to perform at least one of data encryption and data decryption, comprising:
a programmable gate array including at least first, second, third, and fourth substitution boxes, each of said substitution boxes including first, second, third, and fourth look-up tables;
wherein said look-up tables are to generate an n-bit output signal where the n-bit output value is selected from a number of preselected values.

10. The circuit of claim 9 wherein each look-up table is to store 16 preselected values.

11. The circuit of claim 10 wherein m input bits are to be supplied to said substitution boxes to select said n-bit output value.

12. The circuit of claim 11 wherein m is 6 and n is 4.

13. The circuit of claim 12 wherein a subset of said m input bits are used to select one preselected value from each of said first, second, third, and fourth look-up tables in each of said substitution boxes.

14. The circuit of claim 13 wherein each of said substitution boxes includes
a first multiplexer coupled to outputs of said first and second look-up tables;
a second multiplexer coupled to outputs of said third and fourth look-up tables; and
a third multiplexer coupled to outputs of said first and second multiplexers, wherein one of said m input bits is to control said first and second multiplexers and a second of said m input bits is to control said third multiplexer.

15. A method of performing at least one of data encryption and data decryption, comprising:
supplying m input bits to a substitution box in a programmable gate array, said substitution box including at least one look-up table;
generating an n-bit output signal from said at least one look-up table where the n-bit output value is selected from a number of preselected values.

16. The method of claim 15 wherein m is 6 and n is 4

17. The method of claim 16 wherein said at least one look-up table is to store 16 preselected values.

18. The method of claim 17 wherein said substitution box includes first, second, third, and fourth look-up tables.

19. The method of claim 18 further comprising:
selecting with a subset of said m input bits one preselected value from each of said first, second, third, and fourth look-up tables.

20. The method of claim 19 wherein said substitution box includes a first multiplexer coupled to outputs of said first and second look-up tables, a second multiplexer coupled to outputs of said third and fourth look-up tables and a third multiplexer coupled to outputs of said first and second multiplexers, the method further comprising:
controlling said first and second multiplexers with one of said m input bits; and
controlling said third multiplexer with a second of said m input bits.
